(19) United States
(12) Patent Application Publication
(10) Pub. No.: US 2020/0375848 A1
(43) Pub. Date: Dec. 3, 2020

(54) APPARATUS TO FILL AND PACKAGE CAPSULES IN BOTTLES

(71) Applicant: MG2 - S.R.L, PIANORO (IT)

(72) Inventors: Ernesto GAMBERINI, RASTIGNANO (IT); Sergio CICOGNANI, FAENZA (IT)

(21) Appl. No.: 16/890,288

(22) Filed: Jun. 2, 2020

(30) Foreign Application Priority Data
Jun. 3, 2019 (IT) 102019000007869

(51) Int. Cl. A61J 3/07; B65B 1/16

(52) U.S. Cl. CPC A61J 3/074; B65B 1/16

(57) ABSTRACT

An apparatus to fill and package capsules in bottles is provided with a dosing line having a dosing unit to feed at least one pharmaceutical or nutraceutical product into the capsules, a pocket conveyor to move the capsules through the dosing unit, and an output station to release the capsules containing the pharmaceutical or nutraceutical product from the pocket conveyor, and a packaging line having a conveyor device to move, in succession, the bottles through a packaging station connected to the output station so as to receive each capsule released by the pocket conveyor and feed it into a respective bottle.

### CROSS-REFERENCE TO RELATED APPLICATIONS

This patent application claims priority from Italian patent application no. 102019000007869 filed on Jun. 3, 2019, the entire disclosure of which is incorporated herein by reference.

### TECHNICAL FIELD

The present invention relates to an apparatus to fill and package capsules in bottles.

### BACKGROUND OF THE INVENTION

The provision of a plant comprising a filling machine for filling capsules with a pharmaceutical or nutraceutical product, and a packaging line for packaging the capsules containing the pharmaceutical or nutraceutical product in respective bottles is well known in the pharmaceutical field.

Generally, the filling machine comprises a dosing disc comprising, in turn, a hopper for containing the pharmaceutical or nutraceutical product and a dosing system to feed the pharmaceutical or nutraceutical product into the capsules.

The filling machine also comprises a pocket conveyor provided with a plurality of pockets, each of which is designed to house, on the inside, a capsule, and is moved through an input station, where the empty capsules enter the dosing disc, and an output station, where the filled capsules exit the dosing disc.

In the area of the output station, the capsules are released from the pocket conveyor and fed into a storage container.

The packaging line comprises a hopper for containing the filled capsules, a conveyor device to feed the bottles in succession through a packaging station, and a feeding device configured to receive and align the filled capsules coming from the hopper and feed a given number of filled capsules to the packaging station and into each bottle.

The known plants for filling and packaging capsules in bottles of the type described above have some drawbacks mainly due to the fact that transferring the storage container from the filling machine to the packaging line, emptying the storage container into the hopper of the packaging line, and aligning the filled capsules in the feeding device imply a relatively long operating cycle and relatively reduced productivity.

Furthermore, the known plants for filling and packaging capsules in bottles of the type described above are relatively complex, expensive, and bulky due to the presence of the hopper and the feeding device of the packaging line and of a transport device for transferring the storage container from the filling machine to the packaging line.

Furthermore, the known plants for filling and packaging capsules in bottles of the type described above have the further drawback that, when the storage container contains even just one capsule that does not comply with the envisaged requirements, the entire content of the storage container, i.e. a relatively large number of capsules, is discarded.

### SUMMARY OF THE INVENTION

The object of the present invention is to provide an apparatus to fill and package capsules in bottles, which is free from the drawbacks described above and simple and inexpensive to implement.

According to the present invention, an apparatus to fill and package capsules in bottles is provided as claimed in the appended claims.

### BRIEF DESCRIPTION OF THE DRAWINGS

The present invention will now be described with reference to the accompanying drawings, which illustrate a non-limiting embodiment thereof, wherein:

FIG. 1 is a schematic plan view, with parts removed for clarity, of a preferred embodiment of the apparatus of the present invention;

FIG. 2 is a schematic side view, with parts removed for clarity, of a detail of the apparatus in FIG. 1; and

FIG. 3 schematically illustrates the operation of the apparatus in FIG. 1.

### DETAILED DESCRIPTION OF THE INVENTION

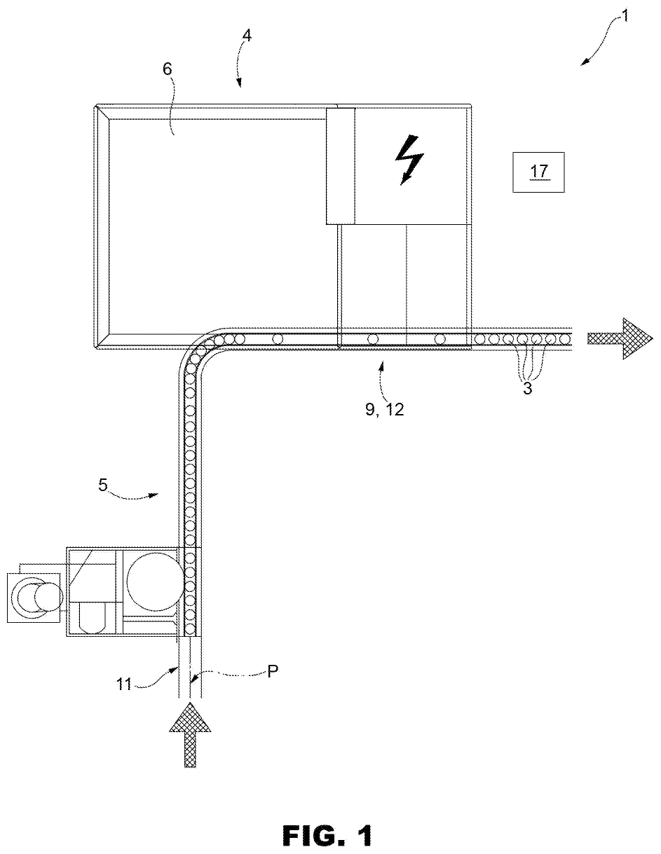

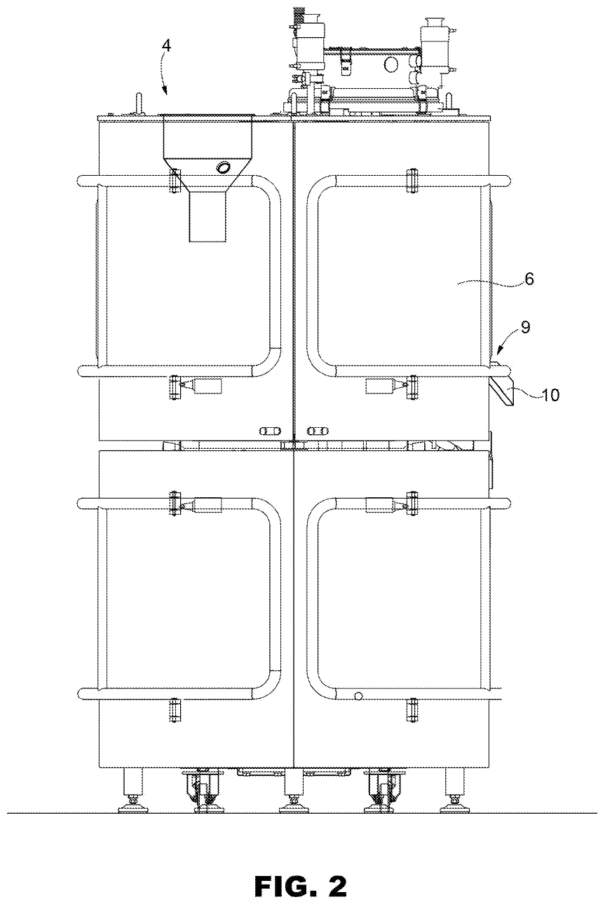

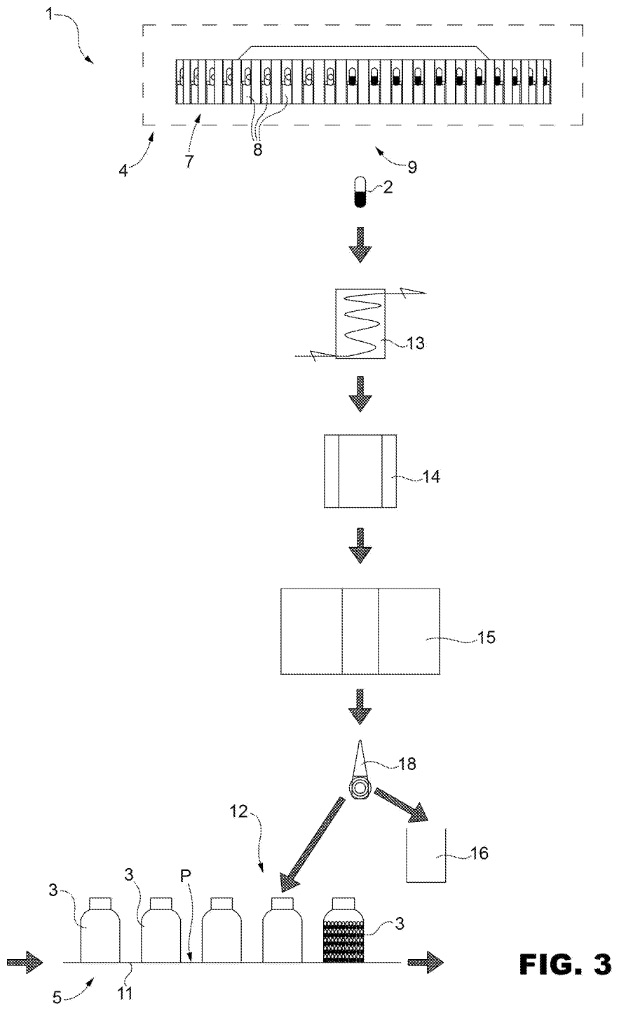

With reference to FIGS. 1, 2, and 3, reference numeral 1 indicates, as a whole, an apparatus for filling and packaging capsules 2 in bottles 3.

The apparatus 1 comprises a dosing line 4 for filling capsules 2 with at least one pharmaceutical or nutraceutical product, and a packaging line 5 for inserting a given number of filled capsules 2 into each bottle 3.

The line 4 comprises a dosing unit 6 of a known type for feeding a given amount of product (the weight of which is measured in the unit 6) into each capsule 2, and a pocket conveyor 7 provided with a plurality of pockets 8, each of which is configured to receive and hold a capsule 2, and is moved by the conveyor 7 through an input station (not shown), where the empty capsules 2 enter the unit 6, and an output station 9, where the filled capsules 2 exit the unit 6.

Each pocket 8 cooperates with a pneumatic suction device (not shown) designed to hold the respective capsule 2 in the pocket 8, and with a pneumatic compressed-air device (not shown), which can be activated at the station 9 to disengage the capsule 2 from the pocket 8 and release it on a discharge chute 10.

The line 5 comprises a conveyor device 11 configured to define a substantially horizontal support surface P for the bottles 3 and move the bottles 3 in succession and intermittently through a packaging station 12 for packaging a given number of filled capsules 2 in each bottle 3.

The station 12 is arranged under the station 9 and the chute 10 so as to receive, in succession, the capsules 2 released by the station 9. In other words, in this case, each capsule 2, once disengaged from its pocket 8, is fed into the respective bottle 3, through falling, from station 9 to station 12.

At the exit of the station 9 and of the chute 10, each capsule 2 crosses, through falling, a dedusting station 13 to clean an outer surface of each capsule 2, a first control station 14 to detect the presence of any metal parts inside each capsule 2, and a second control station 15 for controlling an outer surface of each capsule 2, in succession and in this order.

The apparatus 1 further comprises a collecting station 16, which is obtained downstream of the station 15, and is connected to the station 9 and the chute 10 to receive the capsules 2 discarded by an electronic control unit 17 of the apparatus 1 in response to a signal coming from at least one of the stations 14 and 15.

The apparatus 1 further comprises a deflector device 18 mounted between the station 15 and the stations 12 and 16 and movable between a first operating position, in which the capsules 2 having the correct conformation are fed into the station 12, and therefore into the respective bottles 3, and a second operating position, in which the defective capsules 2 are collected in the station 16.

The apparatus 1 has some advantages mainly due to the fact that the dosing line 4 and the packaging line 5 are integrated with each other and the filled capsules 2 are fed directly from the output station 9 of the line 4 to the packaging station 12 of the line 5, without requiring intermediate storage, a device for transferring the capsules 2 from line 4 to line 5, or a device for aligning the capsules 2 in the line 5.

As a result, the apparatus 1 is relatively simple and inexpensive, and has relatively small dimensions and relatively high productivity.

Furthermore, since the capsules 2 are fed from the station 9 into the respective bottles 3 according to an orderly sequence, the apparatus 1 allows the characteristics of the capsules 2 packaged in each bottle 3 to be known.

Lastly, the presence of a capsule 2 which does not comply with the envisaged requirements involves discarding one bottle 3, that is to say a relatively small number of capsules.

1. An apparatus to fill and package capsules (2) in bottles (3), the apparatus comprising a dosing line (4) to fill capsules (2) with at least one pharmaceutical or nutraceutical product, the dosing line (4) comprising, in turn, a dosing unit (6) to feed the pharmaceutical or nutraceutical product into the capsules (2), a pocket conveyor (7) to move the capsules (2) through the dosing unit (6), and an output station (9) to release the capsules (2) containing the pharmaceutical or nutraceutical product from the pocket conveyor (7); and being characterized in that it comprises, furthermore, a packaging line (5) provided with a conveyor device (11) to move, in succession, the bottles (3) through a packaging station (12) connected to the output station (9) so as to receive each capsule (2) released by the pocket conveyor (7) and feed it into a respective bottle (3).

2. The apparatus according to claim 1, wherein the packaging station (12) is arranged under the output station (9) so as to receive, through falling, the capsules (2) disengaged from the pocket conveyor (7) in the output station (9).

3. The apparatus according to claim 1, wherein the pocket conveyor (7) comprises a plurality of pockets (8), each housing, on the inside, a capsule (2) and cooperating with a pneumatic suction device designed to hold the capsule (2) inside the pocket (8).

4. The apparatus according to claim 3, wherein each pocket (8) cooperates with a pneumatic compressed-air device, which can be activated in the area of the output station (9) so as to disengage the respective capsule (2) from the pocket (8).

5. The apparatus according to claim 1 and comprising, furthermore, a cleaning station (13) mounted between the output station (9) and the packaging station (12) so as to clean an outer surface of each capsule (2).

6. The apparatus according to claim 1 and comprising, furthermore, a first control station (14) mounted between the output station (9) and the packaging station (12) so as to detect the presence of metal parts inside each capsule (2).

7. The apparatus according to claim 1 and comprising, furthermore, a second control station (15) mounted between the output station (9) and the packaging station (12) so as to control an outer surface of each capsule (2).

8. The apparatus according to claim 1 and comprising, furthermore, a collecting station (16) connected to the output station (9) and a deflector device (18) mounted between the output station (9) and said packaging and collecting stations (12, 16) as well as movable between a first operating position, in which the capsules (2) coming from the output station (9) are fed to the packaging station (12), and a second operating position, in which the capsules (2) coming from the output station (9) are fed to the collecting station (16).

9. The apparatus according to claim 8, wherein the deflector device (18) is selectively movable between said first and second operating positions depending on a signal coming from at least one of said first and second control stations (14, 15).
